(19) United States
(12) Patent Application Publication
(10) Pub. No.: US 2026/0358180 A1
(43) Pub. Date: Nov. 12, 2026

(54) HIGH-RESOLUTION DISTRIBUTED SEAWATER TEMPERATURE MONITORING METHOD

(71) Applicants: Xiamen University of Technology, Xiamen City (CN); Xiamen Xinyihe Technology Co., Ltd., Xiamen (CN); China University of Petroleum (East China), Qingdao (CN)

(72) Inventors: Dong SUN, Xiamen City (CN); Mingkun WANG, Xiamen City (CN); Zhongwei LI, Xiamen City (CN); Peichao CHEN, Xiamen City (CN); Yi MA, Xiamen City (CN); Jie ZHANG, Xiamen City (CN)

(21) Appl. No.: 19/632,650

(22) Filed: Mar. 30, 2026

(30) Foreign Application Priority Data
May 6, 2025 (CN) 202510573281.8

(51) Int. Cl. G01K 11/324; G01K 13/02

(52) U.S. Cl. CPC G01K 11/324; G01K 13/026

(57) ABSTRACT

This application provides a high-resolution distributed seawater temperature monitoring method, which involves: (S1) forming a two-dimensional (2D) temperature matrix from distributed Raman signals across consecutive time frames; (S2): denoising this 2D matrix using a non-local means (NLM) algorithm to preserve the overall regional temperature trend; (S3) further denoising the 2D result via a total variation algorithm to retain details in a temperature change region; and (S4) updating the 2D matrix by appending a new Raman signal row, denoising it via NLM algorithm, and using the current regional temperature.

### CROSS REFERENCE TO RELATED APPLICATION

This patent application claims the benefit and priority of Chinese Patent Application No. 202510573281.8, filed with the China National Intellectual Property Administration on May 6, 2025, the disclosure of which is incorporated by reference herein in its entirety as part of the present application.

### TECHNICAL FIELD

The present disclosure relates to the field of seawater temperature monitoring, and in particular to a high-resolution distributed seawater temperature monitoring method.

### BACKGROUND

Seawater temperature is a critical environmental factor for red tides, and 20-30 °C is a suitable temperature range for red tides. A sudden increase in water temperature of 2 °C within one week is a sign of red tides.

The fiber-optic distributed temperature sensing (FO-DTS) system has been developed in recent years to measure spatial temperature field distribution in real time. It utilizes optical waves as information carriers. As optical wave signals propagate in optical fibers, outside environmental factors such as temperatures, electromagnetic fields, and vibrations alter their intensities, polarization states, phases, and other characteristic parameters. By monitoring these changes, environmental monitoring and real-time measurement of the temperature field where the optical fiber is deployed can be achieved. With optical time domain reflectometry (OTDR), measurement points can be accurately positioned. In the prior art, temperature sensing based on Raman anti-Stokes scattering is proposed in “Novel Transient-state Analysis Approach for Distributed Temperature Sensing based on Spontaneous Raman Scattering [J]” (Opto-Electronics Review, 2024). In this technology, the OTDR is used to reconstruct the temperature distribution along the tested optical fiber through differential analysis on the integrated Raman anti-Stokes backscattered signals, realizing the 2 °C temperature resolution and the 1-m spatial resolution. In actual seawater temperature measurement for early warning of red tides, seawater temperature changes are influenced by ocean currents, climates, diurnal temperature variations, and other factors. Meanwhile, such temperature changes are gradual. Noise in the FO-DTS system also impacts the detection results. If denoising methods provided by the prior art are adopted, change trends of the seawater and their details are hardly captured. Hence, the existing distributed seawater temperature measurement methods are challenging to achieve a high resolution.

In view of the above problems in the prior art, a research objective of the present disclosure is to provide a high-resolution distributed seawater temperature monitoring method.

### SUMMARY

In view of the above problems in the prior art, the present disclosure provides a high-resolution distributed seawater temperature monitoring method, to effectively solve at least one problem in the prior art.

The technical solutions of the present disclosure are as follows:

A high-resolution distributed seawater temperature monitoring method includes following steps:
S1: acquiring distributed Raman signals of a to-be-measured seawater region over a plurality of consecutive time frames, and forming a two-dimensional (2D) temperature matrix with a plurality of distributed Raman signals obtained over the plurality of consecutive time frames, where rows of the 2D temperature matrix represent changes of Raman signals at different distances, and columns of the 2D temperature matrix represent changes of the Raman signals in different time frames;
S2: denoising the 2D temperature matrix via a non-local means (NLM) algorithm, preserving an overall temperature trend of the to-be-measured seawater region in the 2D temperature matrix, and obtaining a primarily denoised 2D temperature matrix;
S3: denoising the primarily denoised 2D temperature matrix via a total variation (TV) denoising algorithm, preserving details of a temperature change region in the primarily denoised 2D temperature matrix, and obtaining a secondarily denoised 2D temperature matrix; and
S4: acquiring a distributed Raman signal of the to-be-measured seawater region in a next time frame, adding an acquired distributed Raman signal as a new row after a last row of the secondarily denoised 2D temperature matrix to form a next time-frame 2D temperature matrix, denoising the next time-frame 2D temperature matrix via the NLM algorithm, and taking a last row in a denoised result as a present temperature of the to-be-measured seawater region.

Further, in the step S1, the distributed Raman signals are obtained via repeated sampling and averaging on the Raman signals.

Further, the step S2 specifically includes:
adjusting smoothing parameters of the NLM algorithm, denoising the 2D temperature matrix via an NLM algorithm corresponding to each of the smoothing parameters, calculating a signal-to-noise ratio (SNR) of each denoised result, and obtaining a smoothing parameter with a highest SNR;
dynamically adjusting the smoothing parameter according to an ocean current of the to-be-measured seawater region and a temperature fluctuation of the to-be-measured seawater region; and
denoising the 2D temperature matrix via an NLM algorithm corresponding to a dynamically adjusted smoothing parameter.

Further, the dynamically adjusting the smoothing parameter according to an ocean current of the to-be-measured seawater region and a temperature fluctuation of the to-be-measured seawater region includes:
if the ocean current of the to-be-measured seawater region is located in a local turbulent region, decreasing the smoothing parameter; otherwise, increasing the smoothing parameter; and
if the temperature fluctuation around the to-be-measured seawater region is greater than a preset threshold, decreasing the smoothing parameter; otherwise, increasing the smoothing parameter.

Further, the adjusting smoothing parameters of the NLM algorithm includes:
increasing the smoothing parameters with a step size of 0.1, an initial value of 0.5, and a maximum value of 10.

Further, the high-resolution distributed seawater temperature monitoring method further includes: defining a similarity window of the NLM algorithm as N×N, where N is a positive integer; and
before the denoising the primarily denoised 2D temperature matrix via a TV denoising algorithm, the high-resolution distributed seawater temperature monitoring method further includes: partitioning the primarily denoised 2D temperature matrix based on the N×N.

Further, the step S3 includes:
adjusting regularization parameters of the TV denoising algorithm, denoising the primarily denoised 2D temperature matrix via a TV denoising algorithm corresponding to each of the regularization parameters, calculating an SNR of each denoised result, and obtaining a regularization parameter with a highest SNR;
dynamically adjusting the regularization parameter according to the ocean current of the to-be-measured seawater region and the temperature fluctuation of the to-be-measured seawater region; and
denoising the primarily denoised 2D temperature matrix via a TV denoising algorithm corresponding to a dynamically adjusted regularization parameter.

Further, the dynamically adjusting the regularization parameter according to the ocean current of the to-be-measured seawater region and the temperature fluctuation of the to-be-measured seawater region includes:
if the ocean current of the to-be-measured seawater region is located in the local turbulent region, decreasing the regularization parameter; otherwise, increasing the regularization parameter; and
if the temperature fluctuation around the to-be-measured seawater region is greater than the preset threshold, decreasing the regularization parameter; otherwise, increasing the regularization parameter.

Further, the adjusting regularization parameters of the TV denoising algorithm includes: increasing the regularization parameters with a step size of 0.1, an initial value of 0.1, and a maximum value of 10.

Therefore, the present disclosure has following effects and/or advantages:

The present disclosure acquires the one-dimensional (1D) Raman signals to form the 2D temperature matrix, preserves the overall temperature trend of the to-be-measured seawater region in the 2D temperature matrix with the NLM algorithm, and preserves the details of the temperature change region in the primarily denoised 2D temperature matrix via the TV denoising algorithm, thereby obtaining a temperature field that includes historical trends and details of the seawater temperature. In combination with a newly acquired Raman signal of the next time frame, the present disclosure performs new denoising to obtain the present temperature of the to-be-measured seawater region.

The method provided by the present disclosure improves the resolution of the distributed seawater temperature measurement to ±0.30 °C, which can realize high-resolution monitoring on the seawater temperature for early warning of red tides. Meanwhile, the method provided by the present disclosure has short response time and meets the real-time requirement.

For the method provided by the present disclosure, parameters in the NLM algorithm and the TV denoising algorithm are dynamically adjusted according to the ocean current of the to-be-measured seawater region and the temperature fluctuation of the to-be-measured seawater region. Therefore, the method can adapt to short-term changes of the seawater temperature, preserve the change trend of seawater temperature, and filter out noise.

Other features and advantages of the present disclosure will be described in the following description, and some of these will become apparent from the description or be understood by implementing the present disclosure. The objectives and other advantages of the present disclosure can be implemented and obtained by structures specifically indicated in the description and accompanying drawings.

It is to be understood that both the foregoing summary and the following detailed description are exemplary and explanatory, and are intended to provide further explanation of the present disclosure as claimed.

### BRIEF DESCRIPTION OF THE DRAWINGS

FIG. 1 is a schematic flowchart according to an embodiment of the present disclosure;

FIG. 2 is a schematic diagram of original data of distributed Raman signals;

FIG. 3 illustrates a curve after Raman signals are denoised at 40 °C with a method provided by the present disclosure;

FIG. 4 illustrates a curve after Raman signals are denoised at 60 °C with a method provided by the present disclosure;

FIG. 5 illustrates a curve after Raman signals are denoised at 80 °C with a method provided by the present disclosure; and

FIG. 6 is a schematic diagram of denoising effects of various algorithms.

### DETAILED DESCRIPTION OF THE EMBODIMENTS

In order to facilitate understanding by those skilled in the art, the present disclosure is further described in detail with reference to embodiments.

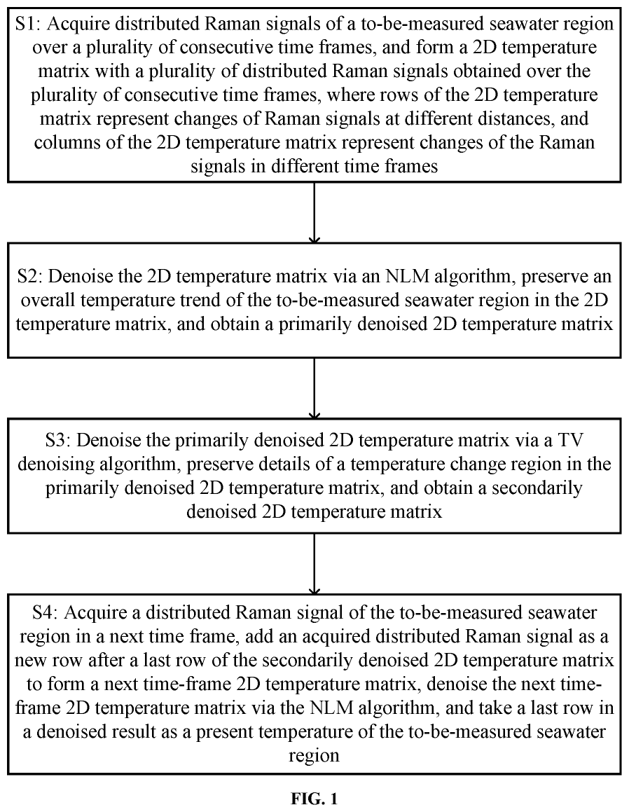

Referring to FIG. 1, a high-resolution distributed seawater temperature monitoring method includes following steps:

S1: Distributed Raman signals of a to-be-measured seawater region over a plurality of consecutive time frames are acquired, and a 2D temperature matrix is formed with a plurality of distributed Raman signals obtained over the plurality of consecutive time frames, where rows of the 2D temperature matrix represent changes of Raman signals at different distances, and columns of the 2D temperature matrix represent changes of the Raman signals in different time frames.

Further, in the step S1, the distributed Raman signals are obtained via repeated sampling and averaging on the Raman signals.

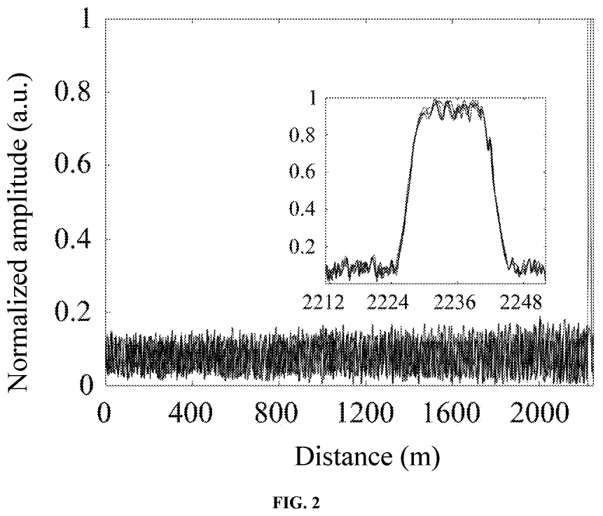

In this step, a temperature of the to-be-measured seawater region is obtained via a Distributed Raman optical fiber temperature sensor. A plurality of gratings are disposed on the optical fiber temperature sensor, and each grating can acquire a temperature signal. Thus, temperature signals corresponding to a plurality of positions are obtained on the optical fiber temperature sensor. In this embodiment, the 2D temperature matrix is constructed by continuously acquiring 20 Raman signals over time frames at a same test temperature. Each Raman signal is obtained via 5,000 accumulations and averaging operations. These signals are then stacked in a time sequence to form the 2D temperature matrix. The rows of the 2D temperature matrix represent the changes of the Raman signals at the different distances, and the columns correspond to different time frames of the Raman signals. Specifically, the sampling is performed on a sensing optical fiber of approximately 2.3 km, with a system sampling interval of 0.4 m. There are 5,635 sampling points for each Raman signal, and 20 signal sequences in total. The 2D temperature matrix has a size of 20×5,635. The profile chart of the 2D temperature matrix is as shown in FIG. 2. FIG. 2 illustrates the original 2D temperature matrix. These trajectories include 20 frames of original Raman signals. A 14-m length of the optical fiber is placed in a water environment with a fixed temperature, and data signals corresponding to the 14-m length are displayed in a magnified manner in FIG. 2.

S2: The 2D temperature matrix is denoised via an NLM algorithm, an overall temperature trend of the to-be-measured seawater region in the 2D temperature matrix is preserved, and a primarily denoised 2D temperature matrix is obtained.

The NLM algorithm reduces noise by considering pixels of similar regions in the 2D temperature matrix. It relies primarily on a similarity between the pixels rather than pixels of local regions, can effectively eliminate noise in the 2D temperature matrix, and preserves details, thereby preserving the overall temperature trend of the to-be-measured seawater region in the 2D temperature matrix.

S3: The primarily denoised 2D temperature matrix is denoised via a TV denoising algorithm, details of a temperature change region in the primarily denoised 2D temperature matrix are preserved, and a secondarily denoised 2D temperature matrix is obtained.

The TV denoising algorithm eliminates noise by minimizing a total variation (TV) of an image (i.e., a sum of pixel gradients). It can effectively reduce noise in the primarily denoised 2D temperature matrix and preserve edges or features corresponding to seawater temperature changes, thereby preserving the details of the temperature change region in the primarily denoised 2D temperature matrix.

In this embodiment, the NLM algorithm is used first for denoising. This can preliminarily reduce optical fiber noise and the like in the 2D temperature matrix, thereby improving quality of temperature data in the 2D temperature matrix, and making the subsequent TV denoising algorithm more stable and efficient. Meanwhile, performing the NLM algorithm first for denoising, followed by the TV denoising algorithm, can prevent the TV denoising algorithm from smoothing out details in the 2D temperature matrix, particularly high-frequency components. If the NLM algorithm is used subsequently for denoising, the effect of the NLM algorithm may be compromised because the 2D temperature matrix has already lost some detail information. Hence, performing the TV denoising algorithm first for denoising may lead to a loss in detail preservation of the image, resulting in the denoising effect of the subsequent NLM algorithm being less than expected.

S4: A distributed Raman signal of the to-be-measured seawater region is acquired in a next time frame, an acquired distributed Raman signal is added as a new row after a last row of the secondarily denoised 2D temperature matrix to form a next time-frame 2D temperature matrix, the next time-frame 2D temperature matrix is denoised via the NLM algorithm, and a last row in a denoised result is taken as a present temperature of the to-be-measured seawater region.

Specifically, based on the original 2D temperature matrix, there is a need to add a new Raman signal to the 2D Raman data matrix denoised by the NLM algorithm to obtain a new data matrix with a size of 21×5635. The previous 20 pieces of data form the secondarily denoised 2D temperature matrix obtained in the step S3, and the 21^{st} piece of added data is the original Raman signal, which is subsequently denoised by the NLM algorithm. Upon the completion of denoising, the 21^{st} piece of data is the present temperature distribution of the sensing optical fiber.

After the newly acquired Raman signal is added as a new row to the 2D matrix, a time span of the matrix is extended. By searching for similar patterns (such as periodic temperature fluctuations) across time frames, the NLM algorithm can more effectively suppress transient noise (such as random sensor errors), while preserving the overall trend of temperature evolution. Therefore, it maximizes the utilization of the temporal variation information of the seawater temperature, preserves the spatiotemporal coherence of the temperature field, inherits the historical denoised results, and ensures that the newly added data is consistent with the historical trend.

Further, the step S2 specifically includes:

Smoothing parameters of the NLM algorithm are adjusted, the 2D temperature matrix is denoised via an NLM algorithm corresponding to each of the smoothing parameters, an SNR of each denoised result is calculated, and a smoothing parameter with a highest SNR is obtained.

The smoothing parameter is dynamically adjusted according to an ocean current of the to-be-measured seawater region and a temperature fluctuation of the to-be-measured seawater region.

The 2D temperature matrix is denoised via an NLM algorithm corresponding to a dynamically adjusted smoothing parameter.

In this step, the NLM algorithm is the prior art. The smoothing parameter is a decay parameter of a Gaussian kernel in weight calculation of the NLM algorithm, and determines a sensitivity of weights between similar blocks. A larger smoothing parameter indicates a stronger smoothing effect but may blur the details. Conversely, a smaller smoothing parameter can preserve more details but may lead to insufficient denoising capability. Initially, how to set the smoothing parameters of the NLM algorithm is unknown. Therefore, by traversing all smoothing parameters in a certain range, the denoising effect of the NLM algorithm on the 2D temperature matrix is adjusted. The smoothing parameter corresponding to the optimal SNR is taken as a basic parameter. Then, the seawater temperature typically changes gradually and is influenced by factors such as a season, a depth, and an ocean current. At the turn of seasons, the seawater temperature changes rapidly. The deeper the seawater, the slower the seawater temperature changes. When the ocean current is located in the local turbulent region, the seawater temperature tends to exhibit more short-term changes. All these changes will increase the occurrence of noise and generate stronger temperature change trends. Therefore, the smoothing parameter needs to be dynamically adjusted, such that the denoised 2D temperature matrix can preserve the trend and details of the seawater temperature at a plurality of levels.

Further, the step that the smoothing parameter is dynamically adjusted according to an ocean current of the to-be-measured seawater region and a temperature fluctuation of the to-be-measured seawater region includes:

If the ocean current of the to-be-measured seawater region is located in a local turbulent region, the smoothing parameter is decreased. Otherwise, the smoothing parameter is increased.

If the temperature fluctuation around the to-be-measured seawater region is greater than a preset threshold, the smoothing parameter is decreased. Otherwise, the smoothing parameter is increased.

Specifically, when the ocean current of the to-be-measured seawater region is located in the local turbulent region, the seawater temperature tends to exhibit more short-term changes. Alternatively, when the temperature change around to-be-measured seawater is significant, such as during temperature transitions, during periods when the sun rises or sets, or when the to-be-measured seawater is in a shallow region, the temperature of the to-be-measured seawater easily changes in short term. In this case, the smaller smoothing parameter is used to preserve these local short-term changes.

Specifically, if the ocean current of the to-be-measured seawater region is located in the local turbulent region, the smoothing parameter is decreased by 20%. Otherwise, the smoothing parameter is increased by 20%.

If the temperature fluctuation around the to-be-measured seawater region is greater than the preset threshold, the smoothing parameter is decreased by 20%. Otherwise, the smoothing parameter is increased by 20%.

Further, the step that the smoothing parameters of the NLM algorithm are adjusted includes:

The smoothing parameters are increased with a step size of 0.1, an initial value of 0.5, and a maximum value of 10.

In this method, by gradually adjusting filtering parameters with a small step size, influences of different smoothing parameters on the denoising effect can be observed.

A similarity window of the NLM algorithm is defined as N×N, where N is a positive integer.

Before the primarily denoised 2D temperature matrix is denoised via the TV denoising algorithm, the high-resolution distributed seawater temperature monitoring method further includes: The primarily denoised 2D temperature matrix is partitioned based on the N×N.

In this step, the size of the similarity window of the NLM algorithm can be manually set. In this embodiment, N is set to 3. Due to the large scale of the 2D temperature matrix obtained in the step S1, directly applying the TV denoising algorithm to the global matrix would result in extremely high computational complexity and memory requirements. By partitioning the 2D temperature matrix into smaller sub-blocks, the TV denoising algorithm can be performed independently on each sub-block. By leveraging parallel computing with multi-core central processing units (CPUs) or graphics processing units (GPUs), the processing speed is significantly improved.

Further, the step S3 includes:

Regularization parameters of the TV denoising algorithm are adjusted, the primarily denoised 2D temperature matrix is denoised via a TV denoising algorithm corresponding to each of the regularization parameters, an SNR of each denoised result is calculated, and a regularization parameter with a highest SNR is obtained.

The regularization parameter is dynamically adjusted according to the ocean current of the to-be-measured seawater region and the temperature fluctuation of the to-be-measured seawater region.

The primarily denoised 2D temperature matrix is denoised via a TV denoising algorithm corresponding to a dynamically adjusted regularization parameter.

Further, the step that the regularization parameter is dynamically adjusted according to the ocean current of the to-be-measured seawater region and the temperature fluctuation of the to-be-measured seawater region includes:

If the ocean current of the to-be-measured seawater region is located in the local turbulent region, the regularization parameter is decreased. Otherwise, the regularization parameter is increased.

If the temperature fluctuation around the to-be-measured seawater region is greater than the preset threshold, the regularization parameter is decreased. Otherwise, the regularization parameter is increased.

Further, the step that regularization parameters of the TV denoising algorithm are adjusted includes:

The regularization parameters are increased with a step size of 0.1, an initial value of 0.1, and a maximum value of 10.

In the above step, the specific adjustment principle of the regularization parameters can be referred to that of the smoothing parameters of the NLM algorithm.

### Experimental Data

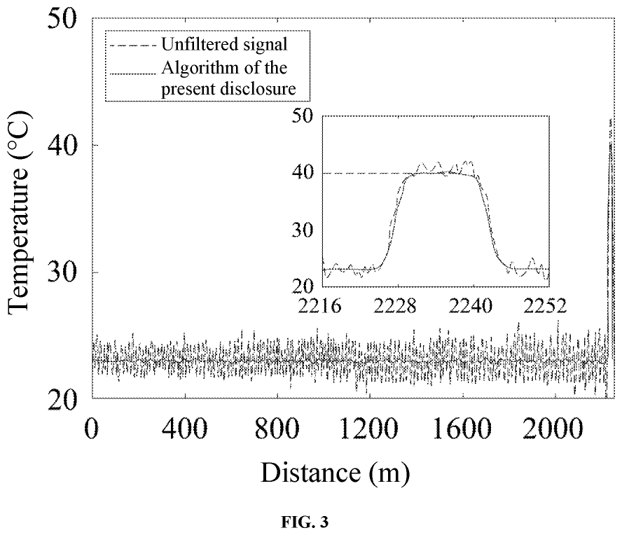

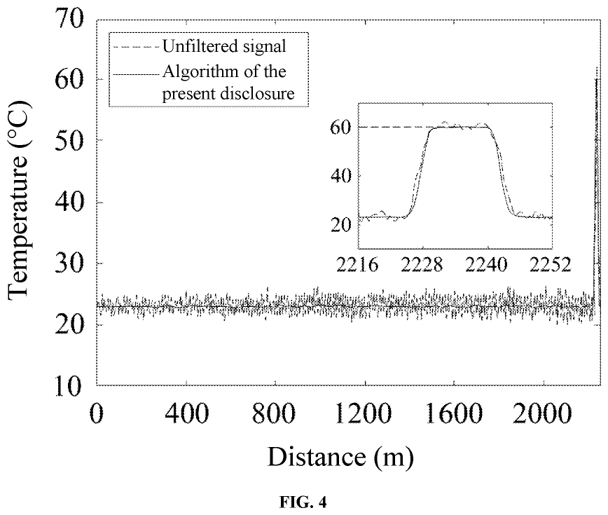

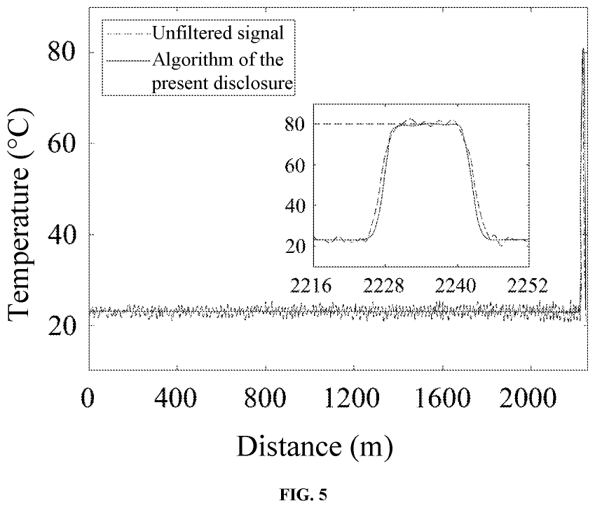

Under a condition where the pulse width is 40 ns, the temperatures for the optical fiber are set to 40 °C, 60 °C, and 80 °C respectively, and the effective temperature measurement length of the optical fiber is 14 m, as shown in FIGS. 3-5, the temperature curves obtained by denoising Raman signals with the method provided by the present disclosure are smoother than the unfiltered temperature curves, and the measured temperatures are close to the preset temperatures for the optical fiber. As can be seen from the figures, through denoising with the method provided by the present disclosure, the temperature accuracy of the Raman signals is improved from ±2.82 °C to ±0.30 °C, thereby effectively eliminating the noise in the Raman signals. Furthermore, this indicates that the method provided by the present disclosure still exhibits certain filtering capability and robustness under different temperatures.

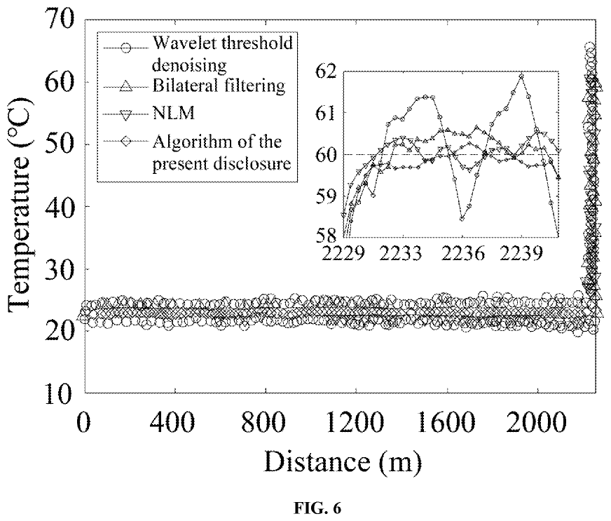

Referring to FIG. 6, by comparing the method provided by the present disclosure with the wavelet threshold denoising algorithm, the 2D NLM algorithm, and the bilateral filtering algorithm in the prior art, when the temperature for the optical fiber is 60 °C, the filtered result of the method provided by the present disclosure is closer to the temperature for the optical fiber. Furthermore, as can be seen from Table 1, the temperature accuracy calculated with the algorithm provided by the present disclosure is highest, and the response time is within an acceptable range, which meets the requirements of high-precision temperature measurement.

TABLE 1
Comparison of different filters on original
Raman signals in denoising performance

| | Response | Temperature |
|---|---|---|
| | time/s | accuracy/°C |
| The present disclosure | 2.32 | ±0.30 |
| Bilateral filtering algorithm | 1.37 | ±0.68 |
| 2D NLM algorithm | 378.69 | ±0.45 |
| Wavelet threshold denoising algorithm | 0.3 | ±1.90 |

In conclusion, the algorithm provided by the present disclosure achieves a good tradeoff between the temperature accuracy and the system's real-time performance. It not only provides high temperature measurement accuracy, but also maintains fast response time, which basically meets the real-time requirements of the Raman-based distributed temperature sensing (RDTS) system. The present disclosure is more suitable for application scenarios that require both the temperature measurement accuracy and the response time.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on at least one computer-usable storage medium (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

Although the preferred embodiments of the present disclosure have been described, those skilled in the art can make additional alterations and modifications to these embodiments once the basic inventive concepts are known. Therefore, the appended claims are intended to be construed to include the preferred embodiments and all alterations and modifications that fall within the scope of the present disclosure.

In this specification, the description of “one embodiment”, “some embodiments”, “an example”, “a specific example” and “some examples” means that a specific feature, structure, material or characteristic described in combination with the embodiment(s) or example(s) is included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without mutual contradiction.

What is claimed is:

1. A high-resolution distributed seawater temperature monitoring method, comprising following steps:
S1: acquiring distributed Raman signals of a to-be-measured seawater region over a plurality of consecutive time frames, and forming a two-dimensional (2D) temperature matrix with a plurality of distributed Raman signals obtained over the plurality of consecutive time frames, wherein rows of the 2D temperature matrix represent changes of Raman signals at different distances, and columns of the 2D temperature matrix represent changes of the Raman signals in different time frames;
S2: denoising the 2D temperature matrix via a non-local means (NLM) algorithm, preserving an overall temperature trend of the to-be-measured seawater region in the 2D temperature matrix, and obtaining a primarily denoised 2D temperature matrix, wherein the step S2 specifically comprises:
adjusting smoothing parameters of the NLM algorithm, denoising the 2D temperature matrix via the NLM algorithm corresponding to each of the smoothing parameters, calculating a signal-to-noise ratio (SNR) of each denoised result, and obtaining a smoothing parameter with a highest SNR;
dynamically adjusting the smoothing parameter according to an ocean current of the to-be-measured seawater region and a temperature fluctuation of the to-be-measured seawater region, comprising:
if the ocean current of the to-be-measured seawater region is located in a local turbulent region, decreasing the smoothing parameter; otherwise, increasing the smoothing parameter; and
if the temperature fluctuation around the to-be-measured seawater region is greater than a preset threshold, decreasing the smoothing parameter; otherwise, increasing the smoothing parameter; and
denoising the 2D temperature matrix via an NLM algorithm corresponding to a dynamically adjusted smoothing parameter;
S3: denoising the primarily denoised 2D temperature matrix via a total variation (TV) denoising algorithm, preserving details of a temperature change region in the primarily denoised 2D temperature matrix, and obtaining a secondarily denoised 2D temperature matrix; and
S4: acquiring a distributed Raman signal of the to-be-measured seawater region in a next time frame, adding an acquired distributed Raman signal as a new row after a last row of the secondarily denoised 2D temperature matrix to form a next time-frame 2D temperature matrix, denoising the next time-frame 2D temperature matrix via the NLM algorithm, and taking a last row in a denoised result as a present temperature of the to-be-measured seawater region.

2. The high-resolution distributed seawater temperature monitoring method according to claim 1, wherein in the step S1, the distributed Raman signals are obtained via repeated sampling and averaging on the Raman signals.

3. The high-resolution distributed seawater temperature monitoring method according to claim 1, wherein the adjusting smoothing parameters of the NLM algorithm comprises:
increasing the smoothing parameters with a step size of 0.1, an initial value of 0.5, and a maximum value of 10.

4. The high-resolution distributed seawater temperature monitoring method according to claim 1, further comprising:
defining a similarity window of the NLM algorithm as N×N, wherein N is a positive integer; and
before the denoising the primarily denoised 2D temperature matrix via a TV denoising algorithm, further comprising: partitioning the primarily denoised 2D temperature matrix based on the N×N.

5. The high-resolution distributed seawater temperature monitoring method according to claim 4, wherein the step S3 comprises:
adjusting regularization parameters of the TV denoising algorithm, denoising the primarily denoised 2D temperature matrix via a TV denoising algorithm corresponding to each of the regularization parameters, calculating an SNR of each denoised result, and obtaining a regularization parameter with a highest SNR;
dynamically adjusting the regularization parameter according to the ocean current of the to-be-measured seawater region and the temperature fluctuation of the to-be-measured seawater region; and
denoising the primarily denoised 2D temperature matrix via a TV denoising algorithm corresponding to a dynamically adjusted regularization parameter.

6. The high-resolution distributed seawater temperature monitoring method according to claim 5, wherein
the dynamically adjusting the regularization parameter according to the ocean current of the to-be-measured seawater region and the temperature fluctuation of the to-be-measured seawater region comprises:
if the ocean current of the to-be-measured seawater region is located in the local turbulent region, decreasing the regularization parameter; otherwise, increasing the regularization parameter; and
if the temperature fluctuation around the to-be-measured seawater region is greater than the preset threshold, decreasing the regularization parameter; otherwise, increasing the regularization parameter.

7. The high-resolution distributed seawater temperature monitoring method according to claim 5, wherein the adjusting regularization parameters of the TV denoising algorithm comprises:
increasing the regularization parameters with a step size of 0.1, an initial value of 0.1, and a maximum value of 10.
